(19) United States
(12) Patent Application Publication
(10) Pub. No.: US 2020/0019782 A1
(43) Pub. Date: Jan. 16, 2020

(54) ACCOMMODATING OBJECT OCCLUSION IN POINT-OF-VIEW DISPLAYS

(71) Applicant: INTERNATIONAL BUSINESS MACHINES CORPORATION, ARMONK, NY (US)

(72) Inventors: CHANDRASEKHAR NARAYANASWAMI, YORKTOWN HEIGHTS, NY (US); UMUT TOPKARA, YORKTOWN HEIGHTS, NY (US)

(21) Appl. No.: 16/035,186

(22) Filed: Jul. 13, 2018

(51) Int. Cl. G06K 9/00; G02B 27/01; G06T 19/00

(52) U.S. Cl. CPC G06K 9/00671; G02B 27/0101; G06T 2207/30241; G02B 2027/014; G06T 19/006

(57) ABSTRACT

A method for accommodating object occlusion in a point-of-view (POV) display device includes projecting, by a point-of-view (POV) display device, an image viewable by a user of the POV display device, receiving an image stream from at least one image acquisition device, recognizing, by a computing device associated with the POV display device and the image acquisition device, one or more objects in the image stream that are visible or predicted to be visible within a field of view of the user that are occluded by an occluding portion of the projected image, determining a significance of the one or more objects relative to the occluding portion of the projected image, and rendering transparent the occluding portion of the projected image based on the significance of the one or more objects wherein the one or more objects are revealed to the user.

### TECHNICAL FIELD

Embodiments of the present disclosure are directed to methods for systems and methods for point-of-view displays and augmenting the visible area from the point of a user with information.

### DISCUSSION OF THE RELATED ART

A point-of-view (POV) display has the promise of bringing wearable computing to the masses, and is gaining traction in the market. A POV display has to actively accommodate daily activities and physical surroundings of the users, and design priority should be on the user's goals and not the computing system. FIG. 1 shows an exemplary head-mounted POV display 10, which includes a head wrap 11, the POV display itself 12, and a camera lens 13 that is sensitive to visible light or infrared (IR) radiation using a thermographic camera. Headphones for audio may be included in the apparatus as well. Picture 14 shows a person wearing the POV display 10. However, visual occlusion of the surroundings in images shown by the POV display is a safety concern, and can also be a potential source of negative social pressure which would create a barrier to adoption by first-time users.

FIG. 2 shows an exemplary vehicular POV display, which projects 2 holographic displays 21, 22 onto the windshield 23 of an automobile. Such displays are currently available on high end automobiles from manufacturers such as BMW. A virtual heads up display can project context-sensitive information 25 onto the windshield as an overlay on the driver's point of view, as shown in picture 24. Examples of such information could include vehicle speed, braking distance, warnings, navigational directions, etc. However, real objects in the physical world may be occluded due to the display overlaying information on them.

Therefore, to be successful, the systems that manage these devices have to incorporate interactions which are mindful of user daily activities, and actively seek to accommodate the needs of these activities as a priority to other goals. Such displays can be found in motor vehicles as projected displays on the dashboard or the windshield, or on point-of-view mobile devices, such as tiny displays in front of one or both of a user's eyes.

While these displays may contain useful information, as explained above, they may occlude objects or views that are more significant to the user's primary goals or may block audio signals from the real world. An example of such object detection is voice/media from items situated in the real world, such as people, speakers, or other audio-visual (AV) equipment. For example, someone who is watching a video in a train and wants to hear an announcement from the conductor about an upcoming stop. Once such media is detected, a point-of-view display system can mute/pause the audio associated with the virtual world.

### SUMMARY

Exemplary embodiments of the present disclosure are directed to systems and methods for managing point-of-view displays to actively remove any occlusions of these objects or views and augmenting the visible area from the point of a user with information.

According to an embodiment of the disclosure, there is provided a method for accommodating object occlusion in a point-of-view (POV) display device, including projecting, by a point-of-view (POV) display device, an image viewable by a user of the POV display device, receiving an image stream from at least one image acquisition device; recognizing, by a computing device associated with the POV display device and the image acquisition device, one or more objects in the image stream that are visible or predicted to be visible within a field of view of the user that are occluded by an occluding portion of the projected image, determining a significance of the one or more objects relative to the occluding portion of the projected image, and rendering transparent the occluding portion of the projected image based on the significance of the one or more objects wherein the one or more objects are revealed to the user.

According to a further embodiment of the disclosure, the method includes notifying the user of the POV display device of the significance of the one or more objects relative to the occluding portion of the projected image.

According to a further embodiment of the disclosure, the method includes selectively displaying in the projected image the one or more objects according to the significance of the one or more objects relative to the occluding portion of the projected image.

According to a further embodiment of the disclosure, the one or more objects and their surroundings are cropped from the image stream and overlaid on the projected image, wherein the one or more objects appear to be in a same place as they would be if the one or more objects were not occluded by the occluding portion of the projected image.

According to a further embodiment of the disclosure, the method includes determining whether to display the one or more objects in the projected image based on a calculated trajectory of the one or more objects.

According to a further embodiment of the disclosure, the method includes selecting, by the user in a setup process, an object to display when occluded by the projected image.

According to a further embodiment of the disclosure, the method includes moving image content of the projected image to a different area of the projected image wherein the one or more objects are visible to the user.

According to a further embodiment of the disclosure, the method includes physically moving the projected image out of the user's point of view wherein the one or more objects are visible to the user.

According to a another embodiment of the disclosure, there is provided a computer program product for accommodating object occlusion in a point-of-view (POV) display device comprising a non-transitory program storage device readable by a computer, tangibly embodying a program of instructions executed by the computer to cause the computer to perform a method that includes projecting, by a point-of-view (POV) display device, an image viewable by a user of the POV display device, receiving an image stream from at least one image acquisition device, recognizing, by a computing device associated with the POV display device and the image acquisition device, one or more objects in the image stream that are visible or predicted to be visible within a field of view of the user that are occluded by an occluding portion of the projected image, determining a significance of the one or more objects relative to the occluding portion of the projected image, and selectively displaying in the projected image the one or more objects according to the significance of the one or more objects relative to the occluding portion of the projected image.

According to a another embodiment of the disclosure, there is provided a system for accommodating object occlusion in a point-of-view (POV) display device, including a point-of-view (POV) display device that projects an image viewable by a user of said POV display device, an image acquisition device that receives an image stream, and a computing device associated with the POV display device and the image acquisition device that recognizes one or more objects in the image stream, determines an occluded object of the one or more objects that would be visible or is predicted to be visible within a field of view of the user but is occluded by an occluding portion of the projected image, and renders transparent the occluding portion of the projected image wherein the occluded object is revealed to the user.

According to a further embodiment of the disclosure, the computing device determines a significance of the occluded object relative to the occluding portion of the projected image; and renders transparent the occluding portion of the projected image based on the significance of the occluded object.

According to a further embodiment of the disclosure, the computing device determines a significance of the occluded object relative to the occluding portion of the projected image; and selectively displays in the projected image the occluded object according to the significance of the occluded object relative to the occluding portion of the projected image.

### BRIEF DESCRIPTION OF THE DRAWINGS

FIG. 1 shows an exemplary head-mounted POV display, according to an embodiment of the disclosure.

FIG. 2 shows an exemplary vehicular POV display, according to an embodiment of the disclosure.

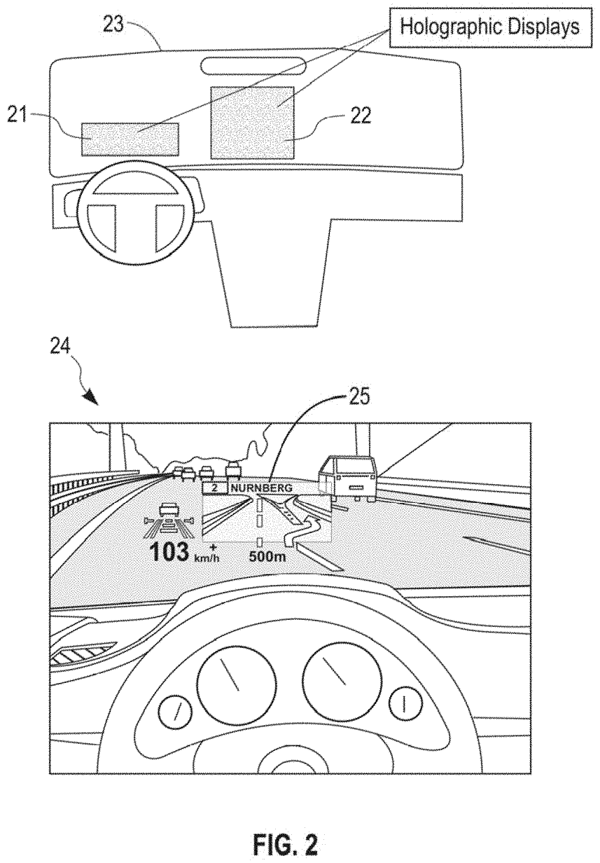

FIG. 3 is a flowchart of a method for accommodating object occlusion in point-of-view (POV) displays, according to embodiments of the disclosure.

FIG. 4 illustrates a method of uncovering occluded objects, according to embodiments of the disclosure.

FIG. 5 illustrates the active monitoring of a target, according to embodiments of the disclosure.

FIG. 6 illustrates a method of recovering occluded objects, according to embodiments of the disclosure.

FIG. 7 illustrates a method of overlaying a picture in a picture, according to embodiments of the disclosure.

FIG. 8 is a schematic of an exemplary cloud computing node that implements an embodiment of the disclosure.

FIG. 9 shows an exemplary cloud computing environment according to embodiments of the disclosure.

### DETAILED DESCRIPTION OF EXEMPLARY EMBODIMENTS

Exemplary embodiments of the disclosure as described herein generally provide systems and methods for managing point-of-view displays to removing occlusions and augmenting the visible area with information. While embodiments are susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

As used herein, the term “image” refers to multi-dimensional data composed of discrete image elements (e.g., pixels for 2-dimensional images and voxels for 3-dimensional images). The image may be, for example, an image of a subject collected by any imaging system known to one of skill in the art. Although an image can be thought of as a function from R³ to R, methods of the disclosure are not limited to such images, and can be applied to images of any dimension, e.g., a 2-dimensional picture or a 3-dimensional volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

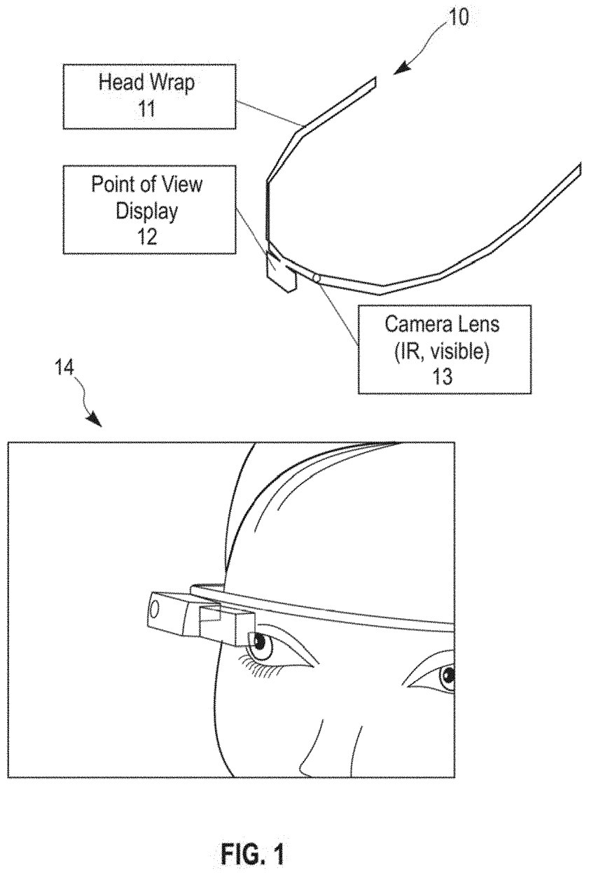

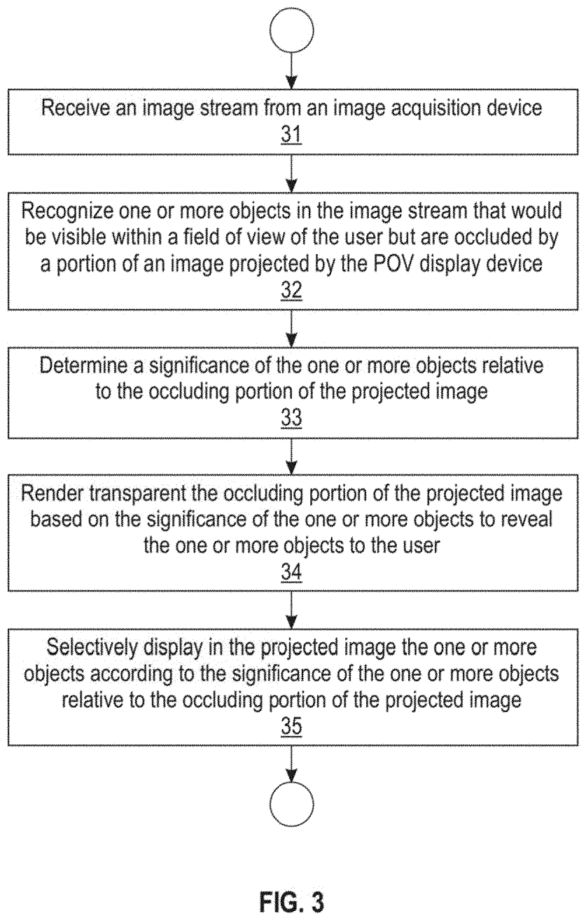

FIG. 3 is a flowchart of a method according to embodiments of the disclosure for accommodating object occlusion in a point-of-view (POV) display. Referring now to the figure, a method according to an embodiment includes receiving an image stream from at least one image acquisition device (step 31); and recognizing, by a computing device associated with the POV display device and the image acquisition device, one or more objects in the image stream that are visible or predicted to be visible within a field of view of the user but are occluded by a portion of an image projected by the POV display device and viewed by a user of the POV display device (step 32). The image acquisition device can be a camera such as that shown in FIG. 1 that is in signal communication with the computing device, and the computing device can be the user's mobile device or a could based server or computer in signal communication with the user's POV display device. A method according to an embodiment further includes determining a significance of the one or more objects relative to the occluding portion of the projected image (step 33), rendering transparent the occluding portion of the projected image based on the significance of the one or more objects to reveal the one or more objects to the user (step 34), and selectively displaying in the projected image the one or more objects according to the significance of the one or more objects relative to the occluding portion of the projected image (step 35).

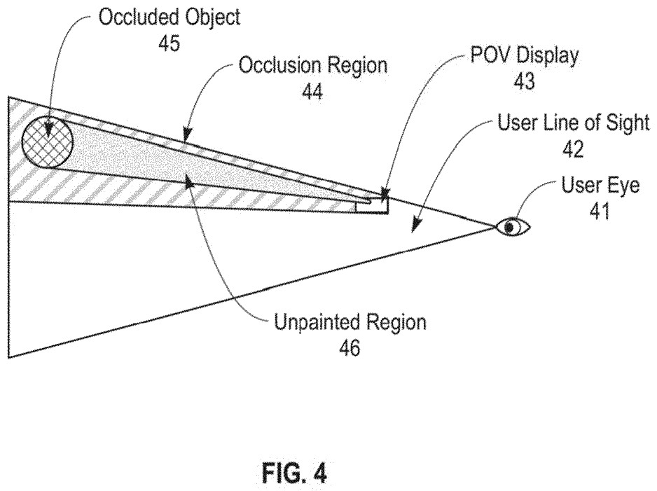

FIG. 4 illustrates a method of uncovering occluded objects, according to embodiments of the disclosure. FIG. 4 shows the line of sight 42 of a user's eye 41. A POV display 43 in the user's creates an occlusion region 44 that occludes object 45. The unpainted region 46 is the part of the display where the display is made transparent if the display is transparent or if no image is projected in that area, analogous to not rendering a part of an image on a projector screen by, e.g., placing a dark object in front of the projector light. Some displays can become transparent or are projected on glass; the display can be partially turned off to reveal an object in the user's line of sight. A method of method of uncovering an occluded object includes using object detection to locate the object, recognizing the object and determining it as being relevant, determining the area on the display where the object would be seen from the point of view of the user, and making the area of the POV display that occludes the object transparent. This can be accomplished by not projecting light to the area, if the display is projected, or by letting the background light coming from the object's direction pass through, if the display is light emitting.

According to embodiments, object detection can be performed with cameras and from video analysis. The objects to look for can be defined on the fly, such as people, cars, a person or a ball. The definitions of what to look for when may be context dependent: driving, watching TV, running on a road, repairing a car, etc. These definitions/preferences can be specified in the cloud and kept resident on the cloud. The cameras can incorporate heat sensing, range finding, etc., as well to assist object finding. In some cases, RFID tags can be attached to the objects and an RFID tag reader in a POV display can detect the objects.

According to embodiments, artificial intelligence (AI) based techniques can also be utilized to learn what areas of the POV display should be unblocked. For example, in some embodiments, a user can currently move or tilt their head to avoid the occlusion by changing the position of the display. An AI system can keep track of such small movements to avoid areas of occlusion. Once learned, the objects can be removed from the occluded view by adjusting the image.

According to embodiments, object recognition can be performed using machine learning, neural networks and other means. In recent years, there have been advances in image recognition that has led to the possibility of autonomous vehicles. According to embodiments, similar image technology can be used. An exemplary, non-limiting image recognition system is the Watson Visual Recognition (see https://www.ibm.com/watson/services/visual-recognition).

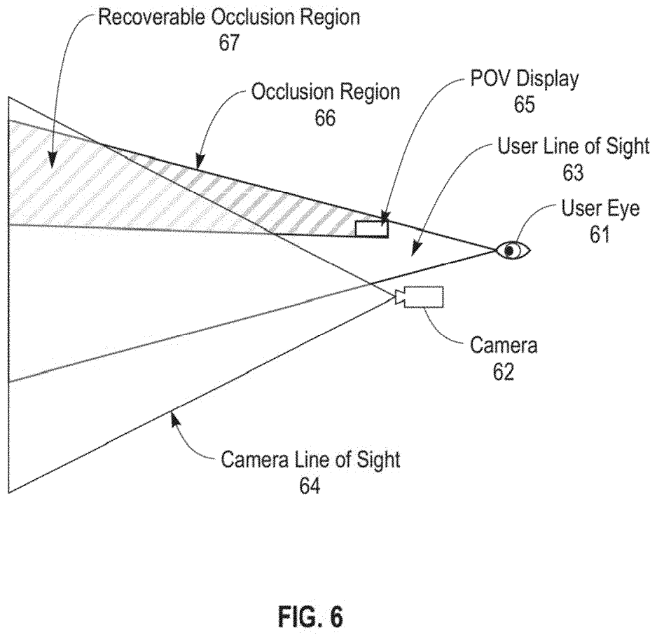

What is occluded can be determined by using the geometry of the eye and the camera, the distance between them, etc., to re-project the image so that the image from the camera is processed to convert it to what the image would look like if the camera were in the same place as the eye. Image-based rendering techniques allow the viewpoint and viewport to be altered within limits by interpolating pixels without acquiring a new image with the new viewpoint and viewport. According to an embodiment, one way would be to put two cameras, one to the left of the eye point and one to the right, and then average the images. More advanced image interpolation techniques can also be used to fuse the left and right images. According to another embodiment, 4 cameras can be used, one in each corner of the POV display, as shown in FIG. 6, and at an angle so the light captured by each camera would go to the center of the eye in the absence of the camera.

According to embodiments, object detection and recognition can be performed in the cloud, by adding a wireless transmitter to a POV display and camera to transmit the captured images/videos to the cloud.

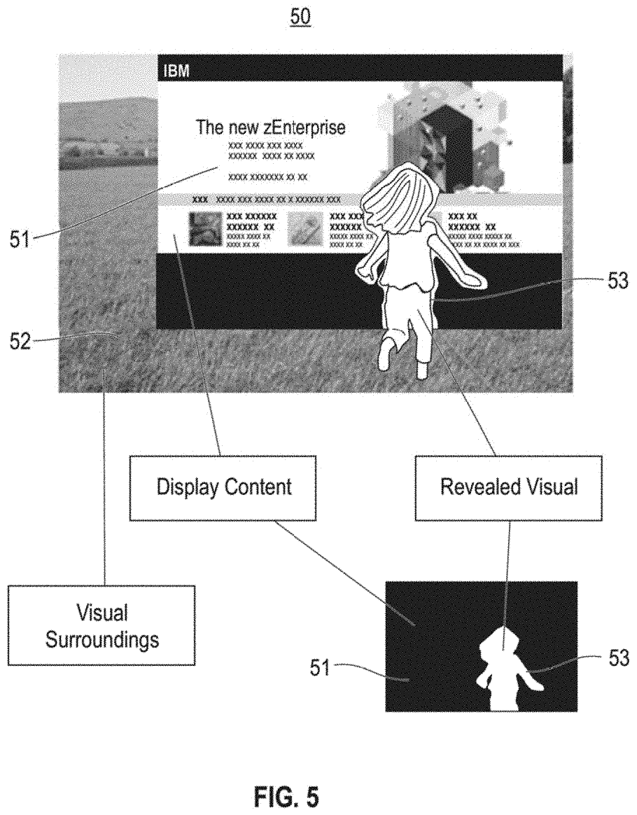

According to embodiments of the disclosure, objects of interest can also be monitored, so that they can be uncovered if they become occluded. A method of active monitoring includes registering s target of interest when setting up the POV display. The POV display system then monitors the target's movements. When the target moves into an occluded region of the POV display, the display is partially or completely disabled; or the target can be painted on the location that would be visible from the user's point of view. FIG. 5 illustrates the active monitoring of a target, and shows the view 50 from a user's POV display, which includes the display content 51, the visible surroundings 52, and a revealed visual 53.

In FIG. 5, the image is actually in front of the eye and projected, but is fairly close to the eye. The child is actually farther away. Now, without a PoV display according to an embodiment, the child would be obscured because a conventional PoV display is projecting an image in that area and the child will be blocked. However, it is desired that the child not be blocked. So PoV display according to an embodiment can detect where the child is with the camera and object recognition and then determine where a PoV display according to an embodiment should not be projecting. When this is accomplished, the child is visible.

If a display does not have the ability to become transparent, a camera can be used to augment the display with an image from the camera and reveal the object in the line of sight of the user. FIG. 6 illustrates a method of recovering occluded objects, according to embodiments of the disclosure. FIG. 6 depicts a user's eye 61 and the user's line of sight 63, a camera 62 and the camera's line of sight 64, the POV display 65, the occlusion region 66, and a recoverable occlusion region 67. Referring now to the figure, object detection is used to locate an object in the camera video feed. The user 61 does not see the video feed, so camera sensors could be capturing invisible wavelengths as well. If the object is recognized as relevant, the object visual is cropped from the video feed, and the location on the display where the object would be seen from the point of view of the user is determined. The object visual is then overlayed on the correct location on the POV display.

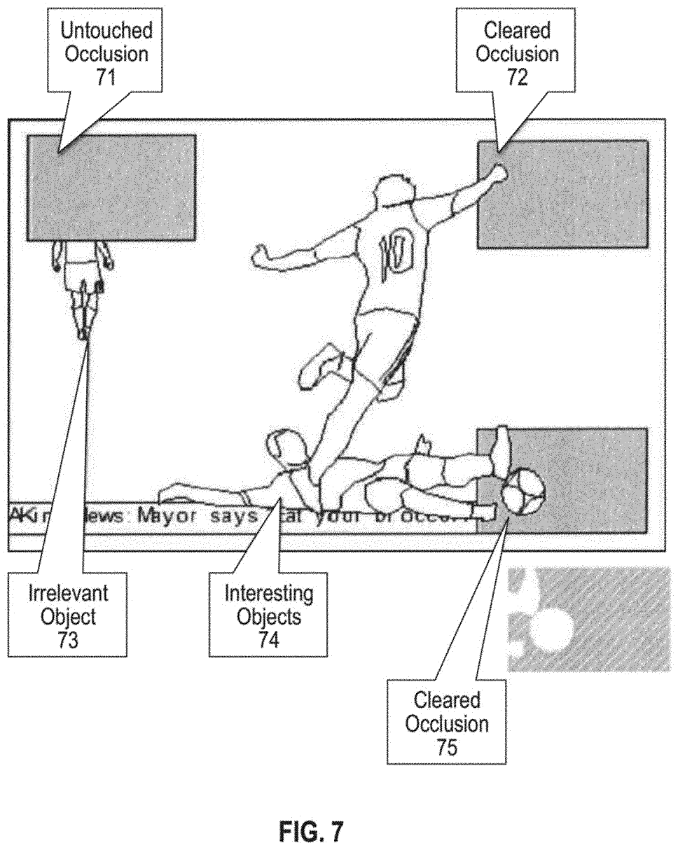

According to further embodiments of the disclosure, multiple video streams can share the same screen in a display. Bounding areas of interesting objects can be sent with a video stream, and a PIP manager decides if an occluding PIP-window is less interesting, and then clears the clipping area of the PIP window and the object. FIG. 7 illustrates a method of overlaying a picture in a picture (PIP), according to embodiments of the disclosure. FIG. 7 shows an untouched occlusion 71 over on an irrelevant object 73, interesting objects 74, and cleared occlusions 72 and 75 over the interesting objects 74.

In further embodiments of the disclosure, the image or video stream can be analyzed to detect motion of objects by comparing the position of the objects in consecutive frames. This will yield a velocity vector for each of the objects that is in motion and an estimate of where the object is going to be in future frames. This estimate can be used to make the projected image transparent in places where the objects in motion are predicted to be.

### System Implementations

It is to be understood that embodiments of the present disclosure can be implemented in various forms of hardware, software, firmware, special purpose processes, or a combination thereof. In one embodiment, an embodiment of the present disclosure can be implemented in software as an application program tangible embodied on a computer readable program storage device. The application program can be uploaded to, and executed by, a machine comprising any suitable architecture. The machine with the suitable architecture can be incorporated into video camera or the POV display device. Furthermore, it is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. An automatic troubleshooting system according to an embodiment of the disclosure is also suitable for a cloud implementation.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

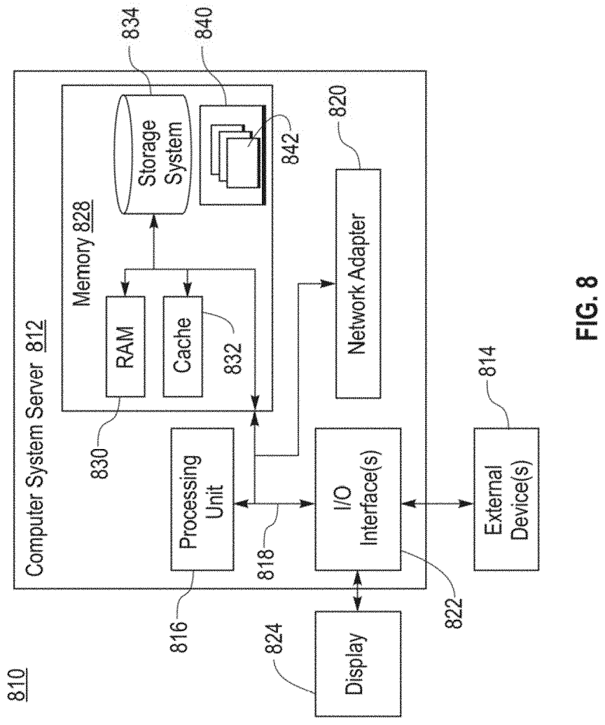

Referring now to FIG. 8, a schematic of an example of a cloud computing node is shown. Cloud computing node 810 is only one example of a suitable cloud computing node and is not intended to suggest any limitation as to the scope of use or functionality of embodiments of the disclosure described herein. Regardless, cloud computing node 810 is capable of being implemented and/or performing any of the functionality set forth hereinabove.

In cloud computing node 810 there is a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 812 may be described in the general context of computer system executable instructions, such as program modules, being executed by a computer system. Generally, program modules may include routines, programs, objects, components, logic, data structures, and so on that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in cloud computing node 810 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 812 typically includes a variety of computer system readable media. Such media may be any available media that is accessible by computer system/server 812, and it includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the disclosure.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the disclosure as described herein.

Computer system/server 812 may also communicate with one or more external devices 814 such as a keyboard, a pointing device, a display 824, etc.; one or more devices that enable a user to interact with computer system/server 812; and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems, etc.

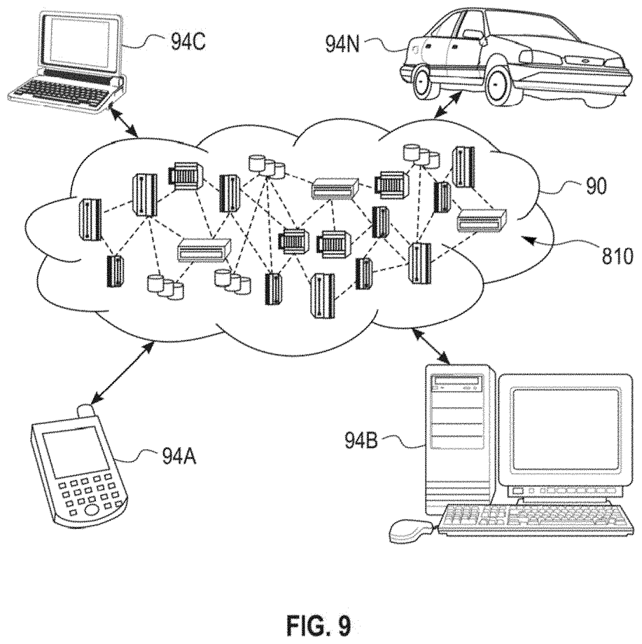

Referring now to FIG. 9, illustrative cloud computing environment 90 is depicted. As shown, cloud computing environment u0 comprises one or more cloud computing nodes 810 with which local computing devices used by cloud consumers, such as, for example, personal digital assistant (PDA) or cellular telephone 94A, desktop computer 94B, laptop computer 94C, and/or automobile computer system 94N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 90 to offer infrastructure, platforms and/or software as services for which a cloud consumer does not need to maintain resources on a local computing device. It is understood that the types of computing devices 94A-N shown in FIG. 9 are intended to be illustrative only and that computing nodes 810 and cloud computing environment 90 can communicate with any type of computerized device over any type of network and/or network addressable connection (e.g., using a web browser).

While embodiments of the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for accommodating object occlusion in a point-of-view (POV) display device, comprising the steps of:
projecting, by a point-of view (POV) display device, an image viewable by a user of the POV display device;
receiving an image stream from at least one image acquisition device;
recognizing, by a computing device associated with the POV display device and the image acquisition device, one or more objects in the image stream that are visible or predicted to be visible within a field of view of the user that are occluded by an occluding portion of the projected image;
determining a significance of the one or more objects relative to the occluding portion of the projected image; and
rendering transparent the occluding portion of the projected image based on the significance of the one or more objects wherein the one or more objects are revealed to the user.

2. The method of claim 1, further comprising notifying the user of the POV display device of the significance of the one or more objects relative to the occluding portion of the projected image.

3. The method of claim 1, further comprising selectively displaying in the projected image the one or more objects according to the significance of the one or more objects relative to the occluding portion of the projected image.

4. The method in claim 3, wherein the one or more objects and their surroundings are cropped from the image stream and overlaid on the projected image, wherein the one or more objects appear to be in a same place as they would be if the one or more objects were not occluded by the occluding portion of the projected image.

5. The method of claim 3, further comprising determining whether to display the one or more objects in the projected image based on a calculated trajectory of the one or more objects.

6. The method of claim 3, further comprising selecting, by the user in a setup process, an object to display when occluded by the projected image.

7. The method of claim 3, further comprising moving image content of the projected image to a different area of the projected image wherein the one or more objects are visible to the user.

8. The method of claim 1, further comprising physically moving the projected image out of the user's point of view wherein the one or more objects are visible to the user.

9. The method of claim 1, further comprising moving image content of the projected image to a different area of the projected image wherein the one or more objects are visible to the user.

10. A computer program product for accommodating object occlusion in a point-of-view (POV) display device comprising a non-transitory program storage device readable by a computer, tangibly embodying a program of instructions executed by the computer to cause the computer to perform a method comprising the steps of:
projecting, by a point-of-view (POV) display device, an image viewable by a user of the POV display device;
receiving an image stream from at least one image acquisition device;
recognizing, by a computing device associated with the POV display device and the image acquisition device, one or more objects in the image stream that are visible or predicted to be visible within a field of view of the user that are occluded by an occluding portion of the projected image;
determining a significance of the one or more objects relative to the occluding portion of the projected image; and
selectively displaying in the projected image the one or more objects according to the significance of the one or more objects relative to the occluding portion of the projected image.

11. The computer program product of claim 10, the method further comprising notifying the user of the POV display device of the significance of the one or more objects relative to the occluding portion of the projected image.

12. The computer program product of claim 10, the method further comprising rendering transparent the occluding portion of the projected image wherein the one or more objects are revealed to the user.

13. The computer program product of claim 10, wherein the one or more objects and their surroundings are cropped from the image stream and overlaid on the projected image, wherein the one or more objects appear to be in a same place as they would be if the one or more objects were not occluded by the occluding portion of the projected image.

14. The computer program product of claim 10, the method further comprising determining whether to display the one or more objects in the projected image based on a calculated trajectory of the one or more objects.

15. The computer program product of claim 10, the method further comprising selecting, by the user in a setup process, an object to display when occluded by the projected image.

16. The computer program product of claim 10, the method further comprising moving image content of the projected image to a different area of the projected image wherein the one or more objects are visible to the user.

17. The computer program product of claim 10, the method further comprising physically moving the projected image out of the user's point of view wherein the one or more objects are visible to the user.

18. A system for accommodating object occlusion in a point-of-view (POV) display device, comprising:
a point-of-view (POV) display device that projects an image viewable by a user of said POV display device;
an image acquisition device that receives an image stream; and
a computing device associated with the POV display device and the image acquisition device that recognizes one or more objects in the image stream, determines an occluded object of the one or more objects that would be visible or is predicted to be visible within a field of view of the user but is occluded by an occluding portion of the projected image, and renders transparent the occluding portion of the projected image wherein the occluded object is revealed to the user.

19. The system of claim 18, wherein the computing device determines a significance of the occluded object relative to the occluding portion of the projected image; and renders transparent the occluding portion of the projected image based on the significance of the occluded object.

20. The system of claim 18, wherein the computing device determines a significance of the occluded object relative to the occluding portion of the projected image; and selectively displays in the projected image the occluded object according to the significance of the occluded object relative to the occluding portion of the projected image.
